(19) United States
(12) Patent Application Publication
(10) Pub. No.: US 2008/0239932 A1
(43) Pub. Date: Oct. 2, 2008

(54) INFORMATION RECORDING AND REPRODUCING APPARATUS

(75) Inventors: Chikayoshi KAMATA, Kanagawa-ken (JP); Kohichi KUBO, Kanagawa-ken (JP); Takayuki TSUKAMOTO, Kanagawa-ken (JP); Shinya AOKI, Kanagawa-ken (JP); Takahiro HIRAI, Kanagawa-ken (JP); Toshiro HIRAOKA, Kanagawa-ken (JP)

Correspondence Address: OBLON, SPIVAK, MCCLELLAND MAIER & NEUSTADT, P.C., 1940 DUKE STREET, ALEXANDRIA, VA, 22314, US

(73) Assignee: KABUSHIKI KAISHA TOSHIBA, Tokyo (JP)

(21) Appl. No.: 12/057,938

(22) Filed: Mar. 28, 2008

(30) Foreign Application Priority Data
Mar. 30, 2007 (JP) 2007-094477
Jun. 12, 2007 (JP) 2007-155702

(51) Int. Cl. G11B 9/00

(52) U.S. Cl. 369/126; 369/288

(57) ABSTRACT

A nonvolatile information recording and reproducing device exhibits low power consumption and high thermal stability. The information recording and reproducing apparatus according to an aspect of the present invention includes a recording layer and a unit for recording information by applying a voltage to the recording layer to generate a resistance change to be caused due to a phase change in the recording layer. The recording layer includes a material having a ramsdelite structure.

### BACKGROUND OF THE INVENTION

1. Field of the Invention

The present invention relates to an information recording and reproducing apparatus with high recording density.

2. Description of the Related Art

In recent years, small-sized portable equipment has been diffused in the world. At the same time, following the great development of high-speed information transport network, demands of small-sized large-capacity nonvolatile memories have rapidly expanded. Above all, in NAND type flash memories and small-sized HDDs (hard disk drives), the recording density has rapidly developed, leading to the formation of a large market.

On the other hand, some ideas of novel memories aiming to greatly exceed the limits of recording density are proposed. For example, transition metal element-containing ternary oxides such as perovskite and spinel (see, for example, JP-A-2005-317787 and JP-A-2006-80258); binary oxides of a transition metal (see, for example, JP-A-2006-140464); and the like are studied. In case of using such a material, a principle in which a low-resistance state (set state) and a high-resistance state (reset state) can be repeatedly changed by application of a voltage pulse, and these two states are made corresponding to binary data of “0” and “1” to record the data is employed.

With respect to writing/erasing, for example, a method in which a pulse is applied in a reverse direction to each other with respect to the time of changing from the low-resistance state to the high-resistance state and the time of changing from the high-resistance state to the low-resistance state is employed in ternary oxides. On the other hand, in binary oxides, there may be the case where the writing/erasing is performed by applying a pulse having a different pulse amplitude or pulse width.

With respect to readout, it is performed by making a readout current flow to an extent that the writing/erasing does not occur in a recording material and measuring an electrical resistance of the recording material. In general, a ratio of the resistance in the high-resistance state and the resistance in the low-resistance state is about 10³. The greatest merit of such materials resides in the matter that even when a device size is reduced to about 10 nm, the recording material is theoretically operable. In that case, since a recording density of about 10 Tbpsi (terabits per square inch) can be realized, such is considered to be one of candidacies for high recording density.

As to an operation mechanism of such novel memories, the following are proposed. As to perovskite materials, diffusion of oxygen deficiency, charge accumulation in an interface level and the like are proposed. On the other hand, as binary oxides, diffusion of an oxygen ion, Mott transition and the like are proposed. Though it is hard to say that the details of the mechanism have been elucidated, since the same change in the resistance is observed in various material systems, such is noticeable as one of candidacies for high recording density.

Besides, MEMS (micro electro mechanical systems) memories using an MEMS technology are proposed. The greatest merit of such MEMS memories resides in the matter that the recording density can be tremendously enhanced because it is not necessary to provide a wiring in each recording part for recording a bit data. As to a recording medium and a recording principle, various proposals are made. By combining the MEMS technology with a new recording principle, attempts to achieve large improvements regarding consumption electric power, recording density, operation speed, etc. are made.

However, a novel information recording medium using such a new recording material has not been realized yet. As one of reasons for this, it is pointed out that the consumption electric power is large and that the heat stability in each resistance state is low (see, for example, S. Seo, et al., Applied Physics Letters, Vol. 85, pp. 5655-5657 (2004)).

### SUMMARY OF THE INVENTION

A information recording and reproducing apparatus according to one aspect of the present invention comprises a recording layer and a unit for recording information by applying a voltage to the recording layer to generate a resistance change to be caused due to a phase change in the recording layer, the recording layer including a material having a ramsdelite structure.

### BRIEF DESCRIPTION OF THE DRAWINGS

FIGS. 1A and 1B are each a view showing a structure of a recording part in an information recording and reproducing apparatus in an embodiment of the invention.

FIG. 2 is a view of a probe memory according to an embodiment of the invention.

FIG. 3 is a view showing the same probe memory according to an embodiment of the invention.

FIG. 4 is a view regarding information recording (set operation) of the probe memory as shown in FIGS. 2 and 3.

FIG. 5 is a view showing a process of information recording (set operation) of the probe memory as shown in FIGS. 2 and 3.

FIG. 6 is a view showing blocks in a data area after completion of information recording of the probe memory as shown in FIGS. 2 and 3.

FIG. 7 is a view for explaining a readout operation of the probe memory as shown in FIGS. 2 and 3.

FIG. 8 is a diagram showing a cross-point type semiconductor memory according to an embodiment of the invention.

FIG. 9 is a view showing an example of a memory cell array structure of the semiconductor memory as shown in FIG. 8.

FIG. 10 is a view showing an example of a memory cell structure of the semiconductor memory as shown in FIG. 8.

FIG. 11 is a view showing an example of a memory cell array structure of the semiconductor memory as shown in FIG. 8.

FIG. 12 is a view showing an example of a memory cell array structure of the semiconductor memory as shown in FIG. 8.

### DESCRIPTION OF THE PREFERRED EMBODIMENTS

An object of the invention is to provide a nonvolatile information recording and reproducing apparatus with low power consumption and high thermal stability.

In order to achieve the foregoing object, the present inventors paid attention to an oxide as a recording layer configuring an information recording and reproducing apparatus. In that case, wiring/erasing on the recording layer is carried out by, for example, applying a voltage to the recording layer to cause a change from a low-resistance state phase to a high-resistance state phase or a change from a high-resistance state phase to a low-resistance state phase. A binary data of “0” and “1” can be made corresponding to a low-resistance state and a high-resistance state, respectively.

Accordingly, in order that in the information recording and reproducing apparatus using the foregoing oxide as a recording layer, signals regarding the foregoing binary data may be recorded and reproduced at a low power consumption and that higher heat stability may be kept, the present inventors made extensive and intensive investigations for the purpose of finding out a mechanism capable of revealing a high-resistance state phase and a low-resistance state phase in the oxide. As a result, it has been found that diffusion of a cation in the oxide and a change in the valence of the ion following this diffusion contribute to the foregoing resistance change phenomenon.

That is, in order to generate a large resistance change at a low power consumption, it has been found that the diffusion of a cation in a recording layer may be made easy. On the other hand, in order to enhance the heat stability in each resistance state, it has been found that it is important to stably keep the state after the cation has been diffused. Namely, when the cation is diffused, a site of a material constituting the recording layer where the cation exists becomes a vacant site, and an electron for neutralizing a charge in the recording layer becomes insufficient so that the recording layer becomes structurally instable. Therefore, it has been found that it is important to separately keep an element capable of supplying the insufficient electron.

From these viewpoints, according to an embodiment of the invention, the recording layer includes a material having a ramsdelite structure. Since this material includes only a tetravalent ion, it does not include a cation which is diffused in the recording layer. Such a recording layer is structurally extremely stable and exhibits high thermal stability.

On the other hand, in the case where the recording layer includes only the foregoing material having a ramsdelite structure, a cation which is diffused in the recording layer to generate a resistance change does not exist. Accordingly, in order to actually perform a recording operation on the recording layer, it is necessary to adequately add a material including a diffusible cation in addition to the foregoing material having a ramsdelite structure. As such a material, a metal capable of becoming a divalent cation can be exemplified. Also, a metal capable of becoming a monovalent cation can be used. In that case, however, since the monovalent ion goes around even at a normal temperature, a phenomenon, for example, poor heat stability is generated. Therefore, such is not preferable so much.

According to an embodiment of the invention, at least one metal element X selected among Zn, Cd, Hg, Mg, Ca, Sr, Cu, Ni, Co, Fe, Mn, Cr and V can be used as the metal capable of becoming a divalent cation. Such a metal element X is able to easily move in the recording layer as a divalent cation via a vacant site of the material having a ramsdelite structure.

Also, according to an embodiment of the invention, the recording layer can include a compound represented by a general formula 1: □ₓYO₂ (wherein □ represents a vacant site in which the metal element X is accommodated; and Y includes at least one element selected among Mn, Ti, V, Cr, Zr, Nb, Mo, Tc, Ru, Rh, Hf, Ta, W, Re, Os and Ir. The material having the foregoing general formula 1 can take the ramsdelite structure.

Above all, Y is preferably at least one element selected from Mn and Re, and especially preferably Mn. Mn and Re have a large mass number and stably exist in the ramsdelite structure, and therefore, they contribute to the stabilization of the ramsdelite structure. In particular, Mn can be prepared as MnO₂ by electrochemically splitting off an Li ion from a spinel structure LiMn₂O₄ to cause a phase change and stably exists without causing collapse of a crystal lattice, and therefore, it is favorable as a constitutional element of the ramsdelite structure.

Furthermore, according to an embodiment of the invention, the recording layer can be formed on a crystal orientation controlling layer including at least a material represented by M₃N₄, M₃N₅, MN₂, M₄O₇, MO₂ or M₂O₅ (wherein M represents at least one element selected among Si, Ge, Sn, Zr, Hf, Nb, Ta, Mo, W, Ce and Tb). According to this, it is possible to satisfactorily achieve the diffusion of a cation utilizing high thermal stability and vacant site without causing collapse of the crystal lattice, namely the ramsdelite structure of the recording layer.

According to an embodiment of the invention, it is possible to obtain a nonvolatile information recording and reproducing apparatus with high thermal stability at a low power consumption.

Other characteristic features, advantages and the like of the invention are hereunder described based on embodiments with reference to the accompanying drawings.

### A. Information Recording and Reproducing Apparatus

In the information recording and reproducing apparatus in this embodiment, its recording part has a stack structure of an electrode layer, a recording layer and an electrode layer (or a passivation layer). In the following, the information recording and reproducing apparatus is described by using MnO₂ having a ramsdelite structure as one example while paying attention to the recording layer as a characteristic portion.

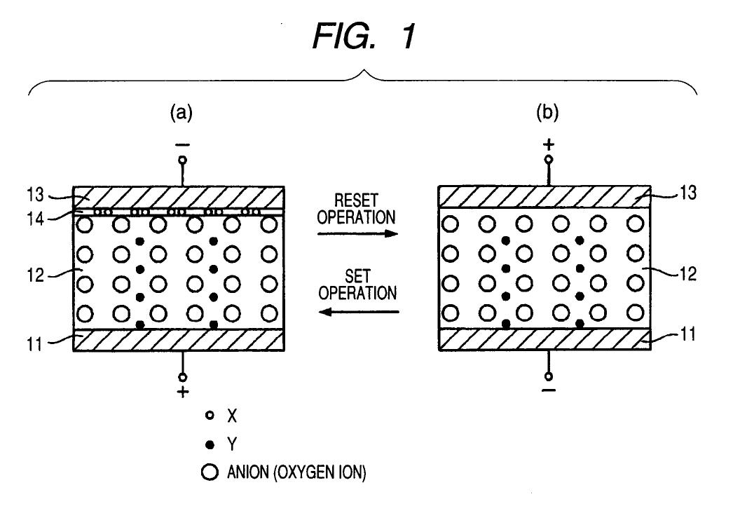

FIG. 1 shows a structure of a recording part in the information recording and reproducing apparatus of this embodiment. 11 denotes an electrode layer; 12 denotes a recording layer; 13 denotes an electrode layer (or a passivation layer); and 14 denotes a metal layer. A large white circle denotes an anion (oxygen ion); a small black circle denotes a transition element cation Y (matrix cation); and a small white circle denotes a typical element X (diffusible cation) to be added.

In FIG. 1A, a large-current pulse is made to flow in the recording layer 12 having the metal layer 14 stacked thereon, and an oxidation-reduction reaction of the recording layer 12 is promoted by Joule heating. A part of the X atom in the metal layer 14 emits an electron into the electrode layer 13 due to residual heat after blocking a large-current pulse and is disposed as the cation X in a vacant site in the crystal of the recording layer 12. Therefore, the recording layer 12 is changed to an insulator (reset operation).

Then, according to an embodiment of the invention, as shown in FIG. 1A, the initial state of each of the recording layer 12 and the metal layer 14 is made as a conductor (low-resistance state phase: set state); and the recording layer 12 is subjected to phase change by Joule heating with a large-current pulse, thereby bring the recording layer 12 with insulating properties (high-resistance state phase: reset state). In the inside of the recording layer 12, the cation X is incorporated. Therefore, the oxygen ion becomes deficient, and the valence of the cation Y in the recording layer 12 is decreased.

Next, when a voltage is applied to the recording layer 12 as shown in FIG. 1B to generate a potential gradient in the recording layer 12, a part of the cation X moves in the crystal. Then, in an embodiment of the invention, the case where the recording layer 12 is an insulator (high-resistance state phase) is made in the initial state, namely the reset state, and the case where the recording layer 12 is subjected to phase change by a potential gradient to bring the recording layer 12 with conductivity (low-resistance state phase) is made in the set state, thereby recording information. For example, a state that a potential of the electrode layer 13 is relatively lower than a potential of the electrode layer 11 is prepared. A negative potential may be applied to the electrode layer 13 by bringing the electrode layer 11 with a fixed potential (for example, a ground potential).

At that time, a part of the cation X in the recording layer 12 moves into the side of the electrode layer (cathode) 13, whereby the cation X in the recording layer (crystal) 12 relatively decreases with respect to the oxygen ion. The cation X which has moved into the side of the electrode layer 13 receives an electron from the electrode layer 13 and deposits as an X atom as a metal, thereby forming a metal layer 14.

In the inside of the recording layer 12, the oxygen ion becomes excessive and increases the valence of the cation Y which remains without being diffused. At that time, when the cation X is selected such that when the valence increases, the electric resistance decreases, the electric resistance decreases due to the movement of the cation X in both the metal layer 14 and the recording layer 12. Therefore, the phase is changed to a low-resistance state phase as a whole of the recording layer. The information recording (set operation) is thus accomplished.

The information reproduction is performed by applying a voltage pulse to the recording layer 12 and detecting a resistance value of the recording layer 12. However, the amplitude of the voltage pulse is made minute to an extent that the movement of the cation X is not generated.

The foregoing process is a sort of electrolysis, and it can be considered that an oxidizing agent is formed due to electrochemical oxidation on the side of the electrode layer (anode) 11, whereas a reducing agent is formed due to electrochemical reduction on the side of the electrode layer (cathode) 13.

In order to put this operation principle to practical use, it must be confirmed that the reset operation is not generated at room temperature (to secure a sufficiently long retention time) and that a consumption electric power of the reset operation is sufficiently low.

It is possible to respond to the former by making the cation X have a valence of 2 or more. According to this, it is possible to disturb the movement of the cation X at room temperature in a state that no potential gradient exists.

Also, it is possible to respond to the latter by finding out a movement path of the cation X which moves in the recording layer 12 because no collapse of the crystal lattice is generated. However, in the case where the recording layer 12 exhibits a ramsdelite structure, and the cation X is disposed in its vacant site, a stable crystal structure similar to a spinel structure can be obtained. Also, since the diffusible cation X is located in a stratiform state, the diffusion of the cation X in the recording layer 12 is easily generated. Accordingly, it is possible to naturally respond to this by making the recording layer 12 have a ramsdelite structure.

Next, the structural stability of the matrix cation is described. The diffusion of the cation and the resistance change phenomenon following this as shown in FIGS. 1A and 1B are found to hold for various crystal structures. Here, in the case where the valence of the matrix cation is large, a larger Coulomb repulsive force functions against a slight deviation of the matrix cation from the crystal lattice, and therefore, the position of the matrix cation is hardly deviated from the crystal lattice. In the ramsdelite structure, since the matrix cation is tetravalent, the matrix structure is easy to stably exist. This matrix cation is preferably Mn, Cr, V, Ti, Zr, Nb, Mo, Tc, Ru, Rh, Hf, Ta, W, Re, Os or Ir.

Furthermore, when the mass of the matrix cation is large, the stability of the matrix cation increases. Therefore, the matrix cation is more preferably Mn or Re, and especially preferably Mn. Mn can be prepared as MnO₂ by electrochemically splitting off an Li ion from a spinel structure LiMn₂O₄ to cause a phase change and stably exists without causing collapse of a crystal lattice. Therefore, Mn constitutes an extremely stable ramsdelite structure. From these viewpoints, in this embodiment, the recording layer 12 having a ramsdelite structure composed of MnO₂ is described in detail.

Subsequently, the diffusible cation is described. As described previously, in order to dispose the diffusible cation X in the vacant site of the recording layer 12, when the diffusible cation is divalent, the diffusion of the diffusible cation and the heat stability are satisfied at the same time. Accordingly, the diffusible cation is preferably divalent. It is preferable to use Zn, Cd, Hg, Mg, Ca, Sr, Cu, Ni, Co, Fe, Mn, Cr or V as the diffusible cation. Of these, Zn, Ni, Co, Fe, Mn and Cu are preferable, with Zn being especially preferable.

Also, since an oxidizing agent is formed on the side of the electrode layer (anode) 11 after the set operation, it is preferable that the electrode layer 11 is constituted of a material which is hardly oxidized (for example, electrically conductive nitrides and electrically conductive oxides). Also, as such a material, ones having no ion conductivity are preferable.

Examples of such a material include those described below. Of these, LaNiO₃ is the most preferable material from the standpoints of overall performance inclusive of good electric conductivity.

(a) MN:

M includes at least one element selected from the group consisting of Ti, Zr, Hf, V, Nb and Ta. N represents nitrogen.

(b) MOₓ:

M includes at least one element selected from the group consisting of Ti, V, Cr, Mn, Fe, Co, Ni, Cu, Zr, Nb, Mo, Ru, Rh, Pd, Ag, Hf, Ta, W, Re, Ir, Os and Pt. The molar ratio x satisfies the relationship of 1≦x≦4.

(c) AMO₃:

A includes at least one element selected from the group consisting of La, K, Ca, Sr, Ba and Ln (lanthanide).

M includes at least one element selected from the group consisting of Ti, V, Cr, Mn, Fe, Co, Ni, Cu, Zr, Nb, Mo, Ru, Rh, Pd, Ag, Hf, Ta, W, Re, Ir, Os and Pt.

O represents oxygen.

(d) A₂MO₄:

A includes at least one element selected from the group consisting of K, Ca, Sr, Ba and Ln (lanthanide).

M includes at least one element selected from the group consisting of Ti, V, Cr, Mn, Fe, Co, Ni, Cu, Zr, Nb, Mo, Ru, Rh, Pd, Ag, Hf, Ta, W, Re, Ir, Os and Pt.

O represents oxygen.

Also, since a reducing agent is formed on the side of the electrode layer (cathode) 13 after the set operation, it is preferable that the electrode layer 13 has a function to prevent a reaction of the recording layer 12 with air from occurring. Examples of such a material include amorphous carbon, diamond-like carbon and semiconductors such as SnO₂.

The electrode layer 13 may be made to have a function as a passivation layer for passivating the recording layer 12; or a passivation layer maybe provided in place of the electrode layer 13. In that case, the passivation layer may be an insulator, or may be a conductor.

Also, for the purpose of efficiently performing the heating of the recording layer 12 in the reset operation, a heater layer (a material having a resistivity of about 10⁻⁵ Ωcm or more) may be provided on the side of the cathode, herein, on the side of the electrode layer 13.

Also, for the purpose of orientation controlling the direction of the ion diffusion path of the recording layer vertically to the membrane surface of the recording layer, it is preferable that a base layer of the electrode layer/recording layer has a material represented by M₃N₄, M₃N₅, MN₂, M₄O₇, MO₂ or M₂O₅ (wherein M represents at least one element selected among Si, Ge, Sn, Zr, Hf, Nb, Ta, Mo, W, Ce and Th). In embodiments, the recording layer can have a (011) orientation.

In the foregoing, while one example in which the recording layer 12 starts from a metal state has been described, the information recording and reproducing apparatus of the invention is also applicable to an example in which the recording layer 12 starts from an insulator state.

### B. Application Examples of Information Recording and Reproducing Apparatus

Next, application examples using the information recording and reproducing apparatus of the invention, for example, a specific memory apparatus is briefly described.

(1) Probe Memory:

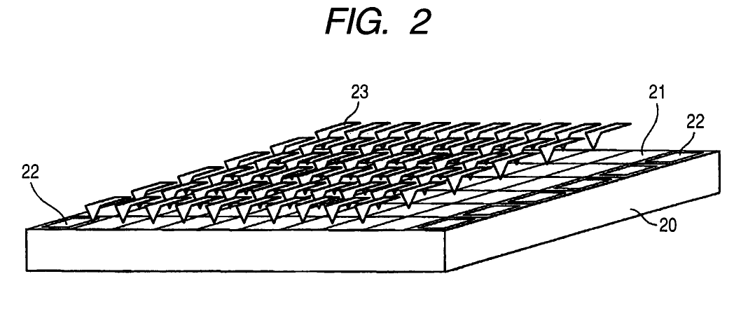

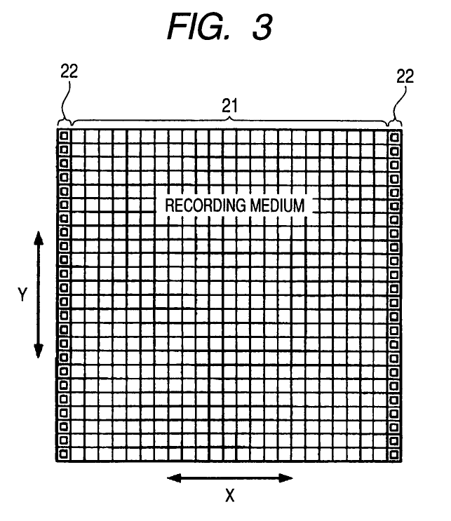

FIGS. 2 and 3 each shows a probe memory according to an embodiment of the invention.

A data area 21 and a servo area 22 are disposed on a semiconductor chip 20. The data area 21 is, for example, configured of a recording medium (recording part) having the structure as shown in FIG. 1. The recording medium is solid formed in a central part of the semiconductor chip 20. Also, the servo area 22 is disposed along an edge of the semiconductor substrate 20.

The data area 21 is configured of plural blocks. Plural probes 23 are disposed corresponding to the plural blocks on the data area 21. Each of the plural probes 23 has an acute shape. In order to perform an access operation, the data area 21 is driven in an X direction and a Y direction in one block by, for example, a driver disposed in the servo area 22.

Also, in place of this, an access operation may be carried out by reciprocating the semiconductor chip 20 or the data area 21 in a Y direction and reciprocating each of the plural probes 23 in an X direction.

Also, by independently forming a recording medium for every block and making the recording medium have a structure such that it is rotated in a circle such as a hard disk, each of the plural probes 23 may be reciprocated in a radius direction of the recording medium, for example, in an X direction.

Each of the plural probes 23 has a function as a writing head and a function as a reproducing head.

Next, the recording/reproducing operation of the probe memory as shown in FIGS. 2 and 3 is described.

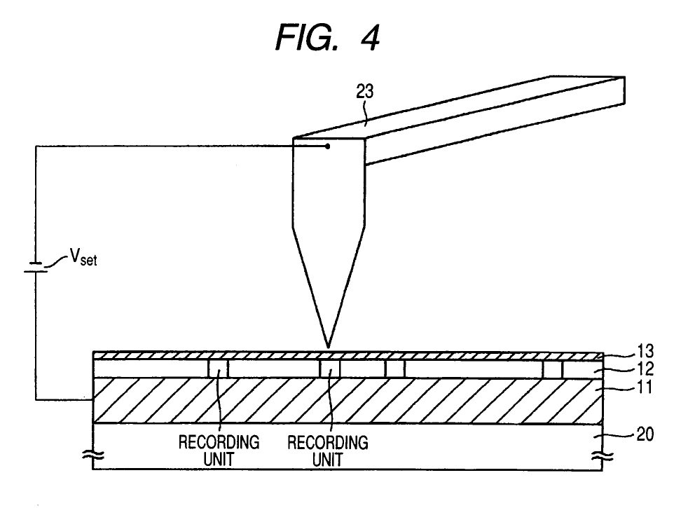

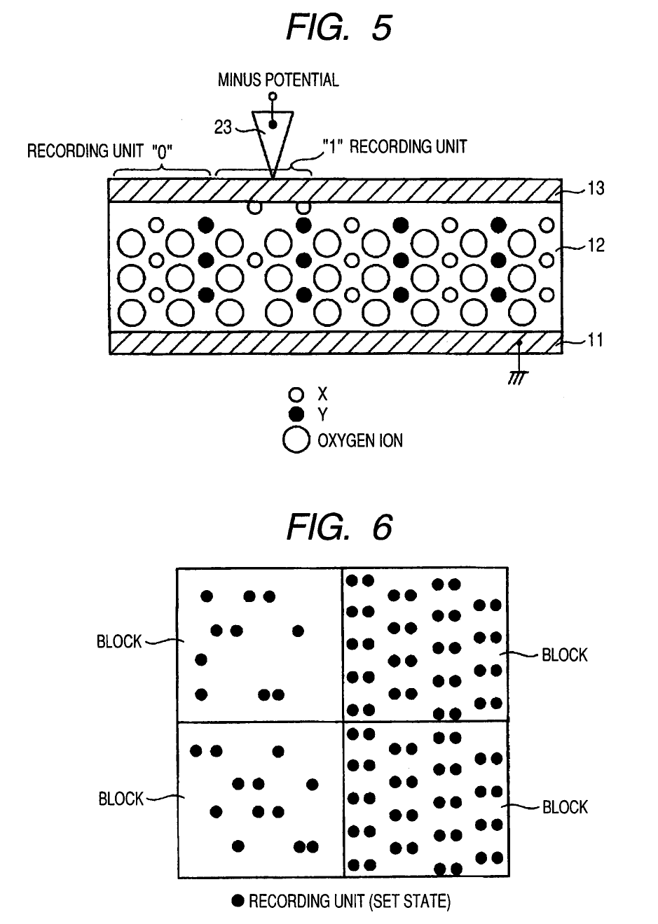

FIG. 4 shows information recording (set operation); and FIG. 5 is an explanatory view showing a process of information recording (set operation). The recording medium is composed of the electrode layer 11, the recording layer 12, the metal layer 14 and the passivation layer 13 in this order on the semiconductor chip 20.

First of all, by bringing a tip of the probe 23 into contact with the surface of the recording part and Joule heating a recording unit of the recording layer (recording medium) 12 by a large-current pulse, the cation X of the metal layer 14 is disposed in the vacant site of the recording layer 12 (forming treatment; reset operation).

The information recording is performed by bringing a tip of the probe 23 into contact with the surface of the recording part and applying a voltage to the recording unit of the recording layer (recording medium) 12 to generate a potential gradient in the recording unit of the recording layer 12. In this embodiment, a state that the potential of the probe 23 is relatively lower than the potential of the electrode layer 11 is prepared. A negative potential may be applied to the probe 23 by bringing the electrode layer 11 with a fixed potential (for example, a ground potential).

A voltage pulse can also be generated and applied by emitting an electron from the probe 23 towards the electrode layer 11 by using, for example, an electron generating source or a hot electron source.

At that time, for example, as shown in FIG. 5, in the recording unit of the recording layer 12, a part of the X ion moves into the side of the probe (cathode) 23, whereby the X ion in the crystal relatively decreases relative to the oxygen ion. Also, the X ion which has moved into the side of the probe 23 receives an electron from the probe 23 and deposits as a metal.

In the recording unit of the recording layer 12, the oxygen ion becomes excessive, resulting in an increase of the valence of the diffusible cation remaining in the recording layer 12. That is, since the recording unit of the recording layer 12 has electron conductivity by the injection of a carrier due to a phase change, the information recording (set operation) is accomplished.

A voltage pulse for achieving the information recording can also be generated by preparing a state that the potential of the probe 23 is relatively higher than the potential of the electrode layer 11.

FIG. 6 shows blocks in the data area after completion of the information recording. A black circle denotes a recording unit which the information recording has been performed. According to the probe memory of this embodiment, not only the information recording can be performed on the recording unit of the recording medium, but a recording density which is higher than that in related-art hard disks and semiconductor memories can be realized by employing a novel recording material.

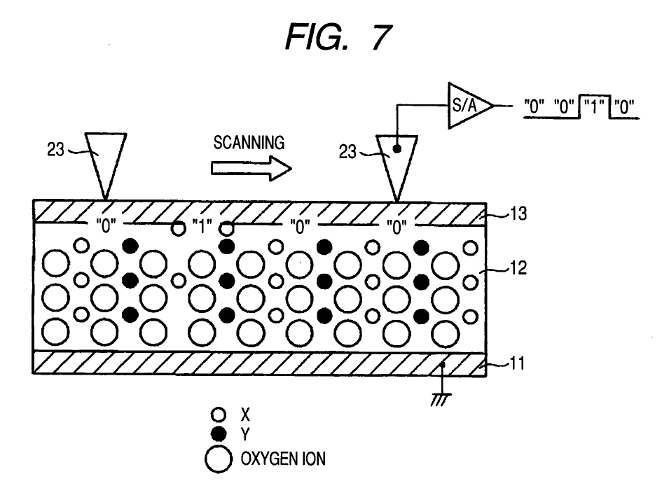

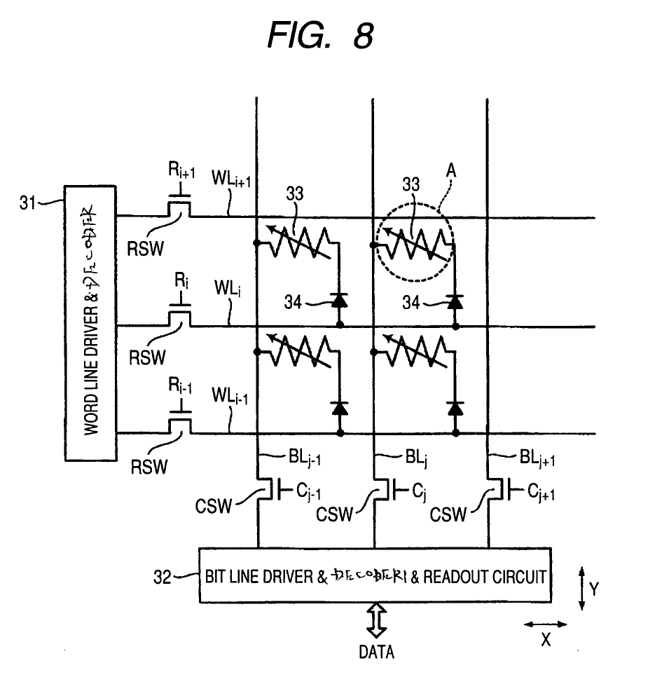

The information reproduction is shown in FIG. 7. The information reproduction is performed by making a voltage pulse flow in the recording unit of the recording layer 12 and detecting a resistance value of the recording unit of the recording layer 12. However, the voltage pulse is a minute value to a degree that the material constituting the recording unit of the recording layer 12 does not cause a phase change.

For example, a readout current generated from a sense amplifier S/A is made to flow from the probe 23 into the recording unit of the recording layer (recording medium) 12, and a resistance value of the recording unit is measured by the sense amplifier S/A. By employing the previously described novel material, it is possible to secure a ratio in resistance between the high-resistance state phase and the low-resistance state phase of 10³ or more.

As to the information reproduction, it is possible to achieve continuous reproduction by scanning by the probe 23 on the recording medium.

An erasing (reset) operation is performed by Joule heating the recording unit of the recording layer 12 by a large-current pulse and promoting an oxidation-reduction reaction in the recording unit of the recording layer 12. Alternatively, the erasing can be performed by applying a voltage pulse which is reversal to that at the time of setting to the recording layer 12.

The erasing operation can be performed in every recording unit or can be performed in a plurality or block unit of the recording unit.

(2) Semiconductor Memory:

FIG. 8 shows a cross-point type semiconductor memory according to an embodiment of the invention.

Word lines WLᵢ₋₁, WLᵢ and WLᵢ₊₁ extend in an X direction; and bit lines BLⱼ₋₁, BLⱼ and BLⱼ₊₁ extend in a Y direction.

One end of each of the word lines WLᵢ₋₁, WLᵢ and WLᵢ₊₁ is connected to a word line driver & decoder 31 via a MOS transistor RSW as a selective switch; and one end of each of the bit lines BLⱼ₋₁, BLⱼ and BLⱼ₊₁ is connected to a bit line driver & decoder & readout circuit 32 via a MOS transistor CSW as a selective switch.

Selective signals Rᵢ₋₁, Rᵢ and Rᵢ₊₁ for selecting a single word line (row) are inputted in a gate of the MOS transistor CSW; and selective signals Cᵢ₋₁, Cᵢ and Cᵢ₊₁ for selecting a single bit line (column) are inputted in a gate of the MOS transistor CSW.

A memory cell 33 is disposed in an intersection between each of the word lines WLᵢ₋₁, WLᵢ and WLᵢ₊₁ and each of the bit lines BLⱼ₋₁, BLⱼ and BLⱼ₊₁ and is of a so-called cross-point type cell array structure.

A diode 34 for preventing a sneak current at the time of recording/reproducing is added in the memory cell 33.

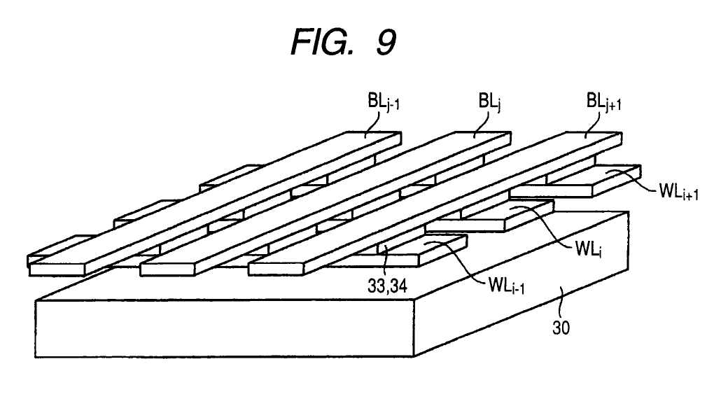

FIG. 9 shows a structure of a memory cell array part of the semiconductor memory as shown in FIG. 8.

The word lines WLᵢ₋₁, WLᵢ and WLᵢ₊₁ and the bit lines BLⱼ₋₁, BLⱼ and BLⱼ₊₁ are disposed on a semiconductor chip 30, and the memory cell 33 and the diode 34 are disposed in each of the intersections between these respective wirings.

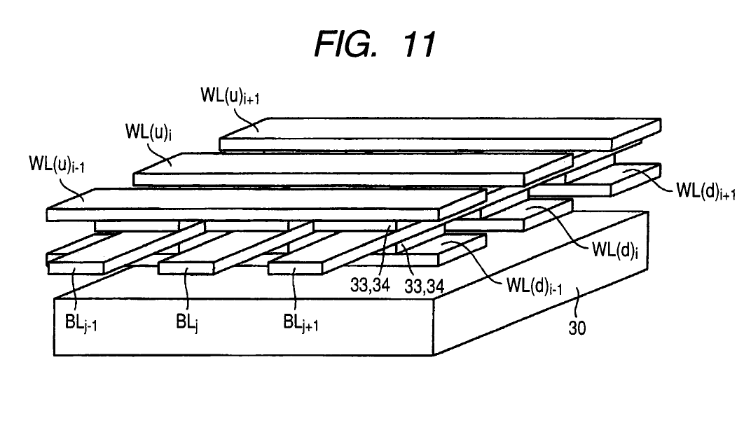

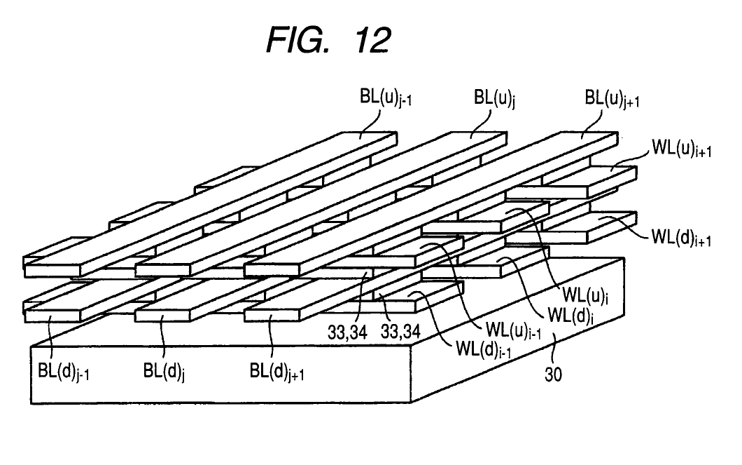

A characteristic feature of such a cross-point type cell array structure resides in an advantage for high integration because it is not necessary to connect a MOS transistor individually to the memory cell 33. For example, as shown in FIGS. 11 and 12, it is possible to make a memory cell array have a three-dimensional structure by stacking the memory cells 33.

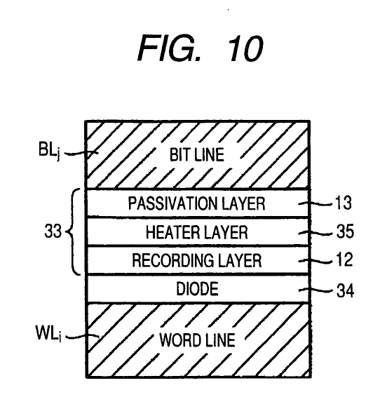

The memory cell 33 is, for example, configured of a stack structure of the recording layer 12, the passivation layer 13 and a heater layer 35 as shown in FIG. 10. One bit data is stored by the single memory cell 33. Also, the diode 34 is disposed between the word line WLᵢ and the memory cell 33.

Next, the recording/reproducing operation is described with reference to FIGS. 8 to 10. Here, the memory cell 33 surrounded by a dotted line A is selected, and a recording/reproducing operation is carried out with respect to this memory cell 33.

First of all, by Joule heating the memory cell 33 surrounded by a dotted line A by a large-current pulse, the cation X of the metal layer 14 is disposed in the vacant site of the recording layer 12 (forming treatment: reset operation).

The information recording (set operation) may be performed by applying a voltage to the selected memory cell 33 to generate a potential gradient in the memory cell 33 and making a current pulse flow. Therefore, for example, a state that the potential of the word line WLᵢ is relatively lower than the potential of the bit line BLⱼ is prepared. A negative potential may be applied to the word line WLᵢ by bringing the bit line BLⱼ with a fixed potential (for example, a ground potential).

At that time, in the selected memory cell 33 as surrounded by the dotted line A, a part of the X ion moves into the side of the word line (cathode) WLᵢ, whereby the X ion in the crystal relatively decreases with respect to the oxygen ion. Also, the X ion which has moved into the side of the word line WLᵢ receives an electron from the word line WLᵢ and deposits as a metal.

In the selected memory cell 33 as surrounded by the dotted line A, the oxygen ion becomes excessive, resulting in an increase of the valence of the Y ion or the Z ion in the crystal. That is, since the selected memory cell 33 as surrounded by the dotted line A has electron conductivity by the injection of a carrier due to a phase change, the information recording (set operation) is accomplished.

At the time of information recording, it is preferable that the non-selected word lines WLᵢ₋₁ and WLᵢ₊₁ and the non-selected bit lines BLⱼ₋₁ and BLᵢ₊₁ are all biased at the same potential.

Also, at the time of standby before the information recording, it is preferable that all of the word lines WLᵢ₋₁, WLᵢ and WLᵢ₊₁ and all of the bit lines BLⱼ₋₁, BLⱼ and BLⱼ₊₁ are pre-charged.

Also, a voltage pulse for achieving the information recording may be generated by preparing a state that the potential of the word line WLᵢ is relatively higher than the potential of the bit line BLⱼ.

The information reproduction is performed by making a voltage pulse flow in the selected memory cell 33 as surrounded by the dotted line A and detecting a resistance value of the memory cell 33. However, it is necessary that the voltage pulse is a minute amplitude to a degree that the material constituting the memory cell 33 does not cause a change in the state.

For example, a readout current generated by the readout circuit is made to flow into the memory cell 33 as surrounded by the dotted line A from the bit line BLⱼ, and a resistance value of the memory cell 33 is measured by the readout circuit. By employing the previously described novel material, it is possible to secure a ratio in resistance between the high-resistance state phase and the low-resistance state phase of 10³ or more.

An erasing (reset) operation is performed by Joule heating the selected memory cell 33 as surrounded by the dotted line A by a large-current pulse and promoting an oxidation-reduction reaction in the memory cell 33.

C. Others

According to an embodiment of the invention, since the information recording (set operation) is carried out only in a site (recording unit) to which an electric field is applied, it is possible to record the information in an extremely minute region at an extremely low power consumption.

Also, the erasing is carried out by applying heat. At that time, by using a material proposed in an embodiment of the invention, a structural change of an oxide is not substantially generated, and therefore, it is possible to achieve the erasing at a low power consumption. Alternatively, the erasing can be carried out by applying an electric field in a reverse direction to that at the time of recording. In that case, since an energy loss namely as heat diffusion is low, the erasing can be achieved at a lower consumption electric power.

In the light of the above, according to an embodiment of the invention, nevertheless an extremely simple construction, the information recording can be achieved in a recording density to an extent that the related-art technologies cannot reach. Accordingly, an embodiment of the invention brings great merits in industry as a next-generation technology capable of defeating the wall of the recording density of the current nonvolatile memories.

An embodiment of the invention is never limited to the foregoing embodiments, and the respective configuration factors can be modified and embodied within the scope from which the gist of the invention does not deviate. Also, various inventions can be constituted by adequately combining the plural configuration factors disclosed in the foregoing embodiment. For example, some configuration factors may be deleted from all the configuration factors disclosed in the foregoing embodiment, or configuration factors of a different embodiment may be adequately combined.

The disclosures of the priority documents, Japanese Patent Application No. P2007-155702, filed Jun. 12, 2007, and Japanese Patent Application No. P2007-94477, filed Mar. 30, 2007, are incorporated by reference herein in their entireties.

1. An information recording and reproducing apparatus comprising a recording medium comprising
a first electrode;
a recording layer on the first electrode; and
at least one of a second electrode and a passivation layer on the recording layer,
wherein the recording layer comprises a material having a ramsdelite crystal structure.

2. The apparatus according to claim 1, wherein the recording layer comprises at least one recording unit produced by applying a voltage to the recording layer to generate a resistance change due to a phase change in the recording layer.

3. The apparatus according to claim 1, wherein the material having a ramsdelite crystal structure comprises a compound represented by the following general formula 1:
□ₓYO₂
where
□ₓ is at least one vacant site in which an element X selected from the group consisting of Zn, Cd, Hg, Mg, Ca, Sr, Cu, Ni, Co, Fe, Mn, Cr and V can be accommodated; and
Y is at least one element selected from the group consisting of Mn, Ti, V, Cr, Zr, Nb, Mo, Tc, Ru, Rh, Hf, Ta, W, Re, Os and Ir.

4. The apparatus according to claim 3, wherein Y is at least one element selected from the group consisting of Mn and Re.

5. The apparatus according to claim 3, wherein Y is Mn.

6. The apparatus according to claim 3, wherein the material having a ramsdelite structure further comprises at least one element X selected from the group consisting of Zn, Cd, Hg, Mg, Ca, Sr, Cu, Ni, Co, Fe, Mn, Cr and V accommodated in the at least one vacant site □ₓ.

7. The apparatus according to claim 3, wherein the material having a ramsdelite structure further comprises at least one element X selected from the group consisting of Zn, Ni, Co, Fe, Mn and Cu accommodated in the at least one vacant site □ₓ.

8. The apparatus according to claim 3, wherein the material having a ramsdelite structure further comprises Zn accommodated in the at least one vacant site □ₓ.

9. The apparatus according to claim 1, wherein
the recording medium further comprises a base layer;
the first electrode is on the base layer; and
the base layer includes at least one material represented by M₃N₄, M₃N₅, MN₂, M₄O₇, MO₂ and M₂O₅, where M represents at least one element selected from the group consisting of Si, Ge, Sn, Zr, Hf, Nb, Ta, Mo, W, Ce and Tb.

10. The apparatus according to claim 9, wherein the base layer controls the crystal orientation of the recording layer.

11. The apparatus according to claim 1, wherein the recording layer has a (011) orientation.

12. The apparatus according to claim 2, wherein the recording medium comprises
the first electrode,
the recording layer on the first electrode, and
the passivation layer on the recording layer; and
the apparatus further comprises at least one probe for applying voltage to the at least one recording unit.

13. The apparatus according to claim 1, wherein
the apparatus further comprises at least one word line and at least one bit line; and
the recording layer is between the at least one word line and the at least one bit line.

14. The apparatus according to claim 1, wherein the recording medium further comprises on the recording layer a heater layer having a resistivity of 10⁻⁵ Ωcm or more.

15. The apparatus according to claim 1, wherein the first electrode comprises MN, where M is at least one element selected from the group consisting of Ti, Zr, Hf, V, Nb and Ta.

16. The apparatus according to claim 1, wherein the first electrode comprises MOₓ, where M is at least one element selected from the group consisting of Ti, V, Cr, Mn, Fe, Co, Ni, Cu, Zr, Nb, Mo, Ru, Rh, Pd, Ag, Hf, Ta, W, Re, Ir, Os and Pt; and 1≦x≦4.

17. The apparatus according to claim 1, wherein the first electrode comprises AMO₃, where
A is at least one element selected from the group consisting of La, K, Ca, Sr, Ba and Ln (lanthanide); and
M is at least one element selected from the group consisting of Ti, V, Cr, Mn, Fe, Co, Ni, Cu, Zr, Nb, Mo, Ru, Rh, Pd, Ag, Hf, Ta, W, Re, Ir, Os and Pt.

18. The apparatus according to claim 1, wherein the first electrode comprises LaNiO₃.

19. The apparatus according to claim 1, wherein the first electrode comprises A₂MO₄, where A is at least one element selected from the group consisting of K, Ca, Sr, Ba and Ln (lanthanide); and
M is at least one element selected from the group consisting of Ti, V, Cr, Mn, Fe, Co, Ni, Cu, Zr, Nb, Mo, Ru, Rh, Pd, Ag, Hf, Ta, W, Re, Ir, Os and Pt.

20. The apparatus according to claim 1, wherein the second electrode comprises at least one selected from the group consisting of amorphous carbon, diamond-like carbon and SnO₂.
